(19) United States
(12) Patent Application Publication
(10) Pub. No.: US 2016/0100263 A1
(43) Pub. Date: Apr. 7, 2016

(54) Active hearing aid implant having adjustable fixation of the actuator end piece in the middle ear

(71) Applicant: HEINZ KURZ GMBH MEDIZINTECHNIK, DUSSLINGEN (DE)

(72) Inventor: Karl-Bernd Huettenbrink, DRESDEN (DE)

(21) Appl. No.: 14/874,756

(22) Filed: Oct. 5, 2015

(30) Foreign Application Priority Data
Oct. 7, 2014 (DE) 102014114494.5

(51) Int. Cl. H04R 25/00

(52) U.S. Cl. CPC H04R 25/606; H04R 2225/67

(57) ABSTRACT

An active hearing aid implant is formed in an arrangement for the adjustment and fixation of the relative position between an axially extended actuator end piece of the hearing aid implant and the surrounding middle-ear bone. Arrangement coupling elements anchor the actuator end piece on the surrounding bone and a sliding ring designed to slide over the cylindrical actuator end piece holds this actuator end piece in a radial direction while the sliding ring remains linearly displaceable in the axial direction of the actuator end piece. Radially protruding coupling elements are fastened radially outwardly on the sliding ring for anchoring the sliding ring on surrounding bone after the arrangement has been surgically inserted into the middle ear.

### CROSS-REFERENCE TO A RELATED APPLICATION

The invention described and claimed hereinbelow is also described in German Priority Document DE 10 2014 114 494.5, filed on Oct. 7, 2014. The German Priority Document, the subject matter of which is incorporated herein by reference, provides the basis for a claim of priority of invention under 35 U.S.C. 119(a)-(d).

### BACKGROUND OF THE INVENTION

The invention relates to an active hearing aid implant having an arrangement for to the adjustment and permanent fixation of the relative position between an actuator end piece of the active hearing aid implant and one more multiple surrounding bones in the human middle ear. The actuator end piece has a shape which is extended along a cylindrical axis, in particular having an elongate shape. The arrangement includes two or multiple coupling elements, by which the actuator end piece, after having been surgically inserted into a human middle ear, is anchored on one or multiple surrounding bones.

Such an active hearing aid implant having a coupling device for an actuator end piece designed as a “floating mass transducer” is known from DE 20 2005 015 533 U1 or US 2012/0158135 A1, for example.

Hearing aid implants are used to conduct the sound that impacts the auricle, or a corresponding sound signal, to the inner ear in cases in which the ossicles of the human middle ear are missing or damaged, entirely or in part. A distinction is made between passive ossicular prostheses, which physically replace parts of the ossicular chain, wherein sound is conducted “passively”, i.e. without the aid of electronic auxiliary means, and active hearing aid implants. Active hearing implants receive electric signals corresponding to the sound signals from an electronic amplifier of a hearing aid, which is mounted outside the middle ear, by an actuator implanted in the middle ear. Active hearing aid implants convert these signals at this point via mechanical motion back to acoustic oscillations and transmit these from a vibrating actuator end piece to the inner ear via suitable connecting elements. Such active hearing aid implants and, in particular, the problems associated with an optimal postoperative spatial fixation and stabilization of the actuator end piece in the inner ear are the subject matter of the present invention.

The diameter of the actuator end piece, which is usually cylindrical, is normally standardized, i.e., is always available in the same size or at least in a group of specific discrete sizes for selection with respect to different unique features of the particular patient.

DE 200 14 659 U1 describes an arrangement for the adjustment and fixation of the relative position between the actuator end piece (“actuator”) of an active hearing aid implant and a component of the human ossicular chain. The known arrangement comprises a connection element having a first coupling element in the form of an insertion sleeve having clamps for coupling to the actuator end piece, having a second coupling element in the form of a clip for coupling to the stapes, and having a shaft-shaped middle part between the first and the second coupling element.

U.S. Pat. No. 5,941,814 provides, as the first coupling element for coupling the connection element to the actuator end piece, a crimping sleeve designed as a hollow cylinder, through which the actuator end piece is inserted during the implantation operation and is subsequently permanently fastened with the aid of a crimping tool by means of cold forming. There is a rigid mechanical connection, e.g., by a welded or soldered point, between the outer side of this crimping sleeve and the shaft-shaped middle part. The problem with this known geometric arrangement is the lack of flexibility for an exact spatial relative-positioning between the vibrating actuator end piece and the first coupling element of the connection element in the middle ear.

It is indeed possible to achieve a certain variability in the direction of the cylindrical axis of the crimping sleeve by inserting the first coupling element to a further or lesser extent into the cylindrical hollow space of the crimping sleeve. It is not at all possible, however, to make an adjustment in the direction perpendicular to this cylindrical axis, and therefore the fine positioning of the connection point between the actuator end piece and the first coupling element in space and, therefore, a precise fixation of the final position of the entire arrangement can only be carried out in a highly imprecise manner. This results in unwanted strain within the implant structure and to a suboptimal geometric adaptation of the relative positions of the individual connection parts, which ultimately results in a substantially poorer frequency response of the entire hearing aid implant and less of an improvement of sound conduction than the entire arrangement could actually technically achieve with the active hearing aid.

A substantial improvement is provided by DE 10 2010 046 457 B3. In this case, however, a first coupling element is geometrically designed in such a way that the first coupling element encloses the actuator end piece with two opposing parallel legs, each of which has a catch device. In the interaction of the two legs, the catch device makes it possible to fix the enclosed actuator end piece in selectable discrete axial positions in a direction parallel to the shaft axis of the shaft-shaped middle part. When the discrete axial clamping positions between the two legs are stepped with adequate geometric fineness, it is therefore possible to achieve an extremely exact spatial adjustment of the coupling point between the actuator end part and the first coupling element, which also considerably improves the possibility of spatially positioning the desired position of the second coupling element in the middle ear.

Such a relatively complicated arrangement is difficult to produce, however, and is therefore cost-intensive. In many more simply designed arrangements known from the prior art, an actuator end piece, designed as a “floating mass transducer”, for example, is simply “freely suspended” in the middle ear by the lead wires, which convey the electric signal from outside the ear and which are mechanically and electrically connected to the actuator end piece, as is presented, for example, in the current brochure entitled “Vibroplasty™ Couplers” from the company bess medizintechnik GmbH, Berlin. In this case, a permanent spatially stable fixation of the actuator end piece is not ensured, however.

A certain amount of rectification is achieved with the coupling device for an actuator end piece designed as a “floating mass transducer,” according to the initially mentioned document DE 20 2005 015 533 U1, which provides for an anchoring of the actuator end piece on one or multiple surrounding bones by elastic wires attached on the side of the floating mass transducer. A disadvantage thereof, however, is that the desired stability and permanent anchoring of the actuator cannot be actually achieved with the thin, elastic wires provided for this in light of the relatively great distances between the actuator and the bone walls of the middle ear extending through the open space. Due to the indications for the use of the implantable hearing aid, and due to the expected postoperative changes, the scar formation or the underlying disease will generate a considerable action of force onto any structure which has been inserted into the middle ear, and long thin wires cannot permanently withstand this action of force due to the far distance between the actuator and the walls of the middle ear. Even a slight bending of the wires will result in a decoupling of the contact point of the actuator with the inner ear.

According to US 2012/0158135 A1, which was also initially mentioned, the actuator is stretched between the incus and the base of stapes. All stabilizer elements are each mechanically connected to a part which is moved by the actuator.

### SUMMARY OF THE INVENTION

The present invention overcomes the shortcomings of known arts, such as those mentioned above.

To that end, the invention provides an active hearing aid implant having an arrangement for the adjustment and permanent fixation of the relative position between an actuator end piece of the active hearing aid implant and one more multiple surrounding bones in the human middle ear, where the arrangement is implemented using the simplest possible technical means, in a simple and low-cost manner. The novel arrangement ensures not only that the actuator end piece can be conveniently surgically inserted into the human middle ear and can be stably coupled to the stapes or, if needed, to a corresponding connection piece to the inner ear, but also ensures a permanently exact positional fixation of the actuator end piece even in the presence of laterally acting forces, such as, e.g., cicatricial pulls, movements caused by fluctuations in air pressure, etc., thereby ensuring, in the end, that the acoustic vibrations in the form of sound waves generated by the actuator are better conducted to the stapes or to the parts of the hearing aid implant leading to the inner ear.

In an embodiment, the arrangement has a sliding ring, which is geometrically designed in such a way that the sliding ring can be slid over the cylindrical actuator end piece and then holds this actuator end piece in the radial direction, while the sliding ring remains linearly displaceable in the axial direction of the actuator end piece, against a frictional resistance, if necessary, and two or multiple radially protruding coupling elements are fastened radially outwardly on the sliding ring for anchoring the sliding ring on one or multiple surrounding bones after the arrangement has been surgically inserted into a human middle ear.

The loose installation of the actuator, which enables the actuator to slide, in the sliding ring provided according to the invention, ensures a constant positioning of the actuator, with the coupling element thereof, relative to the stapes irrespective of axially acting forces, since the actuator can be easily slid to the optimal position for coupling to the stapes. The radially protruding coupling elements also enable anchoring in the biologically preformed bone openings of the middle-ear muscles directly next to the oval window, which bone openings are located so as to be only slightly separated from the sliding ring, thereby making it possible to avoid disadvantageous great spacing distances to the outer walls of the middle ear and thereby avoid resultant lever actions on the coupling elements. The risk of a dislocation caused by cicatricial pulls, bleeding, etc., is minimized as a result.

Embodiments of the arrangement according to the invention in which the sliding ring is made from metal and/or ceramic and/or plastic in order to achieve an absolute minimal sliding friction on the actuator end piece are particularly preferred and are relatively easy to produce.

In order to simplify the insertion and the monitoring of the correct position of the actuator end piece, in other advantageous embodiments of the invention, the sliding ring is designed as a closed ring or a half-open ring having a slot.

In one form, the actuator end piece has a cylindrical design having identical cross-sections along the cylindrical axis thereof. This makes it possible to optimally position the actuator end piece within the sliding ring provided according to the invention.

In another form, the actuator end piece is barrel-shaped, having different cross-sections along the cylindrical axis thereof, and has, in the middle region thereof, a bulge in the radial direction in order to provide for the most friction-free contact with the actuator possible during variable positioning of the sliding ring.

In one hearing aid implant embodiment, the actuator end piece is preferably designed as an inductor coil or a piezoelectric coupling rod or as a magnet of a FMT (=“floating mass transducer”). The invention can therefore include all actions and designs of an actuator which are currently technically possible.

In light of a particularly high variability of the adaptation of the anchoring of the sliding ring onto the anatomy of the human middle ear, the inventive arrangement includes that the radially protruding coupling elements for anchoring the sliding ring are bar-shaped or rod-shaped. Alternatively, arrangement includes that the radially protruding coupling elements for anchoring the sliding ring are made from wire, wherein the wire has a certain minimum thickness in order to ensure a stable anchoring even in the event of strong postoperative cicatricial pulls or movements such as those resulting from fluctuations in air pressure.

In an embodiment, the hearing aid implant includes exactly two coupling elements that are disposed opposite one another on the sliding ring and protrude radially from the sliding ring, in order to secure the anchoring with respect to a lateral tilting of the sliding ring.

In another embodiment, at least three coupling elements, which are arranged so as to be symmetrically distributed around the periphery of the sliding ring and which protrude radially from the sliding ring, are provided in order to permit anchoring on as many anatomically variable coupling points on the middle-ear walls as possible.

In another embodiment, the hearing aid implant includes that the remote ends of the coupling elements protruding from the sliding ring are designed to be inserted into natural, anatomically present openings in the surrounding mastoid bone, in particular in a tendon channel of the stapedius muscle and/or the tensor tympani muscle, in order to insert and anchor the active hearing aid implant in a human middle ear. This makes it possible for the otologist to use these natural anchoring points on the walls of the human middle ear, which are actually the only ones and which are already anatomically present and are extremely stable, for a permanently stable and exact positioning of the actuator end piece.

The initially mentioned document DE 20 2005 015 533 U1 merely provides that the wires be anchored “in the bone”. The aforementioned document does not describe how these wires are supposed to be anchored in the bone. A person skilled in the art must therefore assume that it is intended for bores to be created in the bone, because there is no way to enter the bone without a bore. The idea disclosed in DE 20 2005 015 533 U1 per se therefore cannot be implemented without introducing bores into the bone surrounding the patient's middle ear. Such bores for fastening structures in the bone have already been known per se for a very long time.

In contrast thereto, the present invention enables use of the natural openings provided by nature in the bone channels of the stapedius tendon and the tendon of the tensor tympani muscle. These natural openings and channels in the bone also remain stable in the patient's ear for the rest of the patient's life. When a bore is created in the bone, however, an inserted wire can (and most likely will) “wander around” due to the permanent reconstruction processes in the bone, and therefore a magnet fastened thereto, for example, may lose its hold. This is absolutely not the case with the naturally present tendon openings relied upon by the invention. The present invention makes it possible to use these openings as anchoring points provided by nature, more or less as a bionic anchoring in the middle ear.

In contrast to the initially mentioned document US 2012/0158135 A1, in the hearing aid implant according to the present invention, the coupling elements acting as stabilizers are not anchored on parts which are movable, in particular being movable by the actuator, but rather on fixed structures remote from the actuator, namely on the surrounding mastoid bone.

In order to ensure optimization of the friction fit between the actuator end piece and the sliding ring while simultaneously maintaining the oscillation capability even during the intraoperative manipulations carried out while inserting the hearing aid implant, the arrangement according to the invention, or parts thereof, is made from material having a memory effect, in particular from a nickel-titanium alloy, preferably from Nitinol, either entirely or in part, at least in the region of the sliding ring and/or the coupling elements.

It is known that titanium, in particular, in addition to being stiff and having excellent sound-conducting properties, also exhibits excellent biocompatibility with the human middle ear. In light of a postoperative positional adjustment, the coupling element preferably is made entirely or in part from a material having a memory effect or superelastic properties, for example, from a nickel-titanium alloy, and preferably from Nitinol, which is known per se from WO 02/069850 A1 or U.S. Pat. No. 6,554,861 B2, for example, although only in the context of passive ossicular prostheses.

As an alternative or in addition thereto, in further embodiments, parts of the arrangement according to the present invention can be made from a ceramic material.

Further preferred embodiments of the arrangement according to the invention include that a fastening device is mounted on the free lower end of the actuator end piece directed toward the inner-ear region in the implanted state, The fastening device is fastened on the free lower end of the actuator end piece by a coupler crown and is fastened on the stapes by a clip or a bell, which is slotted, in particular. It is thereby possible to ensure a slip-proof, acoustically hard connection of the actuator to the stapes as the acoustic inlet into the inner ear.

If the natural stapes in the patient's middle ear is no longer present or is too greatly deformed, it is possible to use, as the connection to the inner ear region, e.g., artificial coupling elements designed as pistons or balls or elements shaped as a clip or a bell for coupling to the head of the stapes, which is still present to a sufficient extent, or as a receiving part for an Ω-shaped, artificial base of stapes or as a plunger for coupling onto the natural base of stapes. To this end, DE 10 2009 016 468 B3, for example, describes embodiments of such a fastening element as a piston, plunger, or a slotted bell. However, none of these known coupling elements are parts of active hearing aid implants of the type in question, but rather are passive ossicular prostheses of a different type, and provide no suggestion of the geometric design of the first coupling element of the active hearing aid implant of the invention.

In another embodiment, a tympanic membrane plate is mounted on the free upper end of the actuator end piece, which is directed toward the tympanic membrane region in the implanted state. The tympanic membrane plate, in the implanted state thereof, rests against the tympanic membrane or a flat piece of cartilage inserted between the tympanic membrane and the actuator end piece in order to reliably prevent the tympanic covering from being moved through/penetrated, also during subsequent displacements of the tympanic membrane.

After the hearing aid implant has been surgically placed in the middle ear, the so-called recovery phase begins. Scars form during this period, and these produce unforeseeable forces which can cause the prosthesis to move out of the local position thereof, which was set exactly during the operation. If the connection to the coupling elements is too stiff, elevated pressure peaks can occur, which, in turn, could result in damage to the implant. For this reason it is very helpful when this portion of the active hearing aid implant has a certain postoperative mobility, thereby enabling the active hearing aid implant to automatically adapt, postoperatively, to a changed position in the edge regions. Since it also is possible for the unique anatomical features of the ear, such as the position, shape and size of the stapes, incus, hammer and tympanic membrane to vary, it is highly advantageous when hearing aid implants are not designed to be rigid, but rather such that these have a certain amount of flexibility or variability.

In addition to the above-described postoperative shifting of position, a further problem results once hearing aid implants have been implanted. That is, the middle ear of the human body may be described as a “semi-open region”. Any implantation material that is inserted in the body within the scope of reconstruction of the middle ear and its structures thereby undergoes a particular stress which predominates in a contaminated and infected environment, and which typically attacks the material. Since the objective of implanting a hearing aid implant must always be to enable the implant to remain in the patient's middle ear for as long as possible without complications occurring, a sustained attack on the material may result in damage being done to the implant and/or in a local infection. Neither of these consequences is tolerable.

In an embodiment, in order to permanently prevent damage from occurring to the implantation material or the surrounding tissue, a biologically active coating, in particular a growth-inhibiting and/or growth-promoting and/or antibacterial coating is provided, at least in sections, in order to improve the acceptance while reducing the risk of rejection and infection of the implant.

Therefore, for example, a further fastening element, which leads directly into the inner ear and is designed, e.g., in the shape of a piston, will have a growth-inhibiting

### BRIEF DESCRIPTION OF THE DRAWINGS

Further features and advantages of the invention will become apparent from the description of embodiments that follows, with reference to the attached figures, wherein:

FIG. 1a presents a schematic spatial representation, diagonally from above, of an embodiment of the active hearing aid implant according to the invention;

FIG. 1b presents a schematic spatial representation, diagonally from below, of the embodiment of the active hearing aid implant shown in FIG. 1a;

FIG. 1c presents a schematic spatial representation, diagonally from below, of the embodiment of the active hearing aid implant shown in FIG. 1a;

FIG. 2a presents a schematic spatial representation, diagonally from above, of another embodiment of the active hearing aid implant according to the invention;

FIG. 2b presents a schematic spatial representation, diagonally from below, of the embodiment in FIG. 2a; and

FIG. 2c presents a schematic spatial representation, in a side view diagonally from below, of the embodiment in FIG. 2a.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

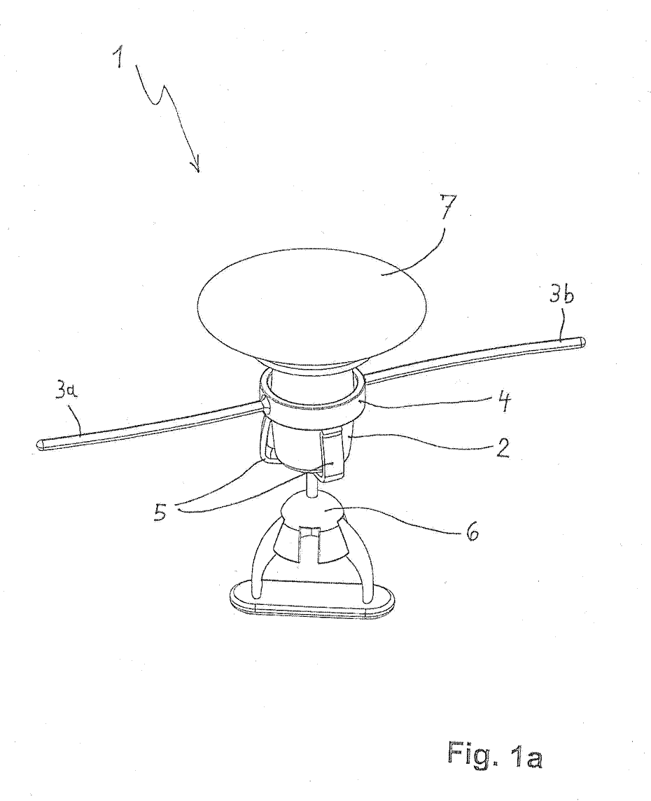

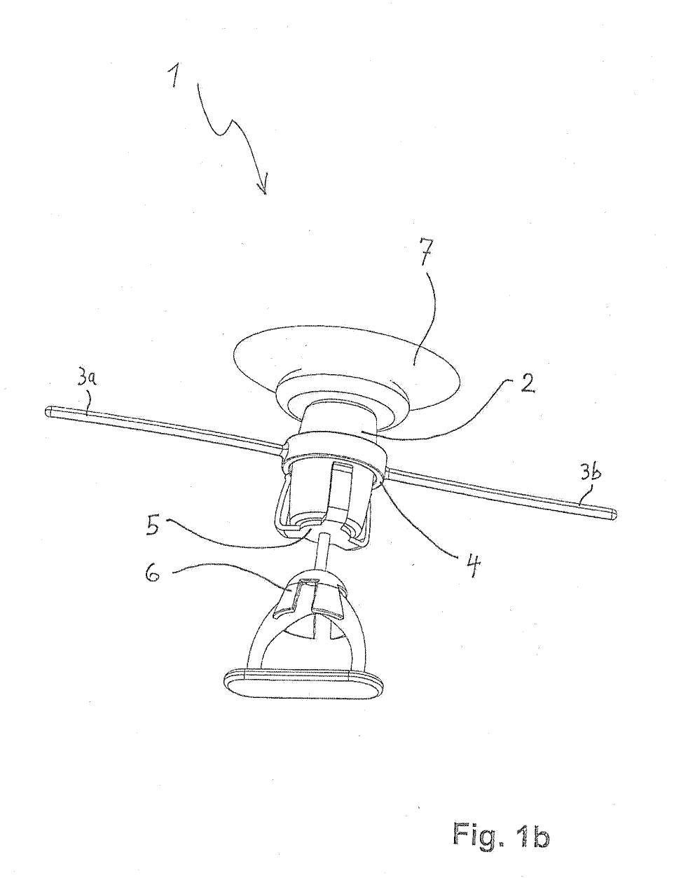

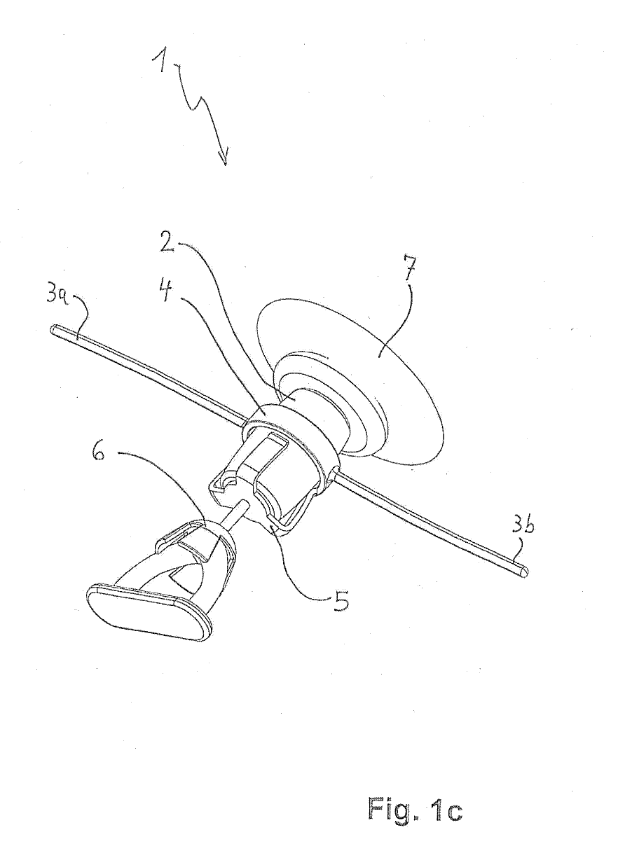

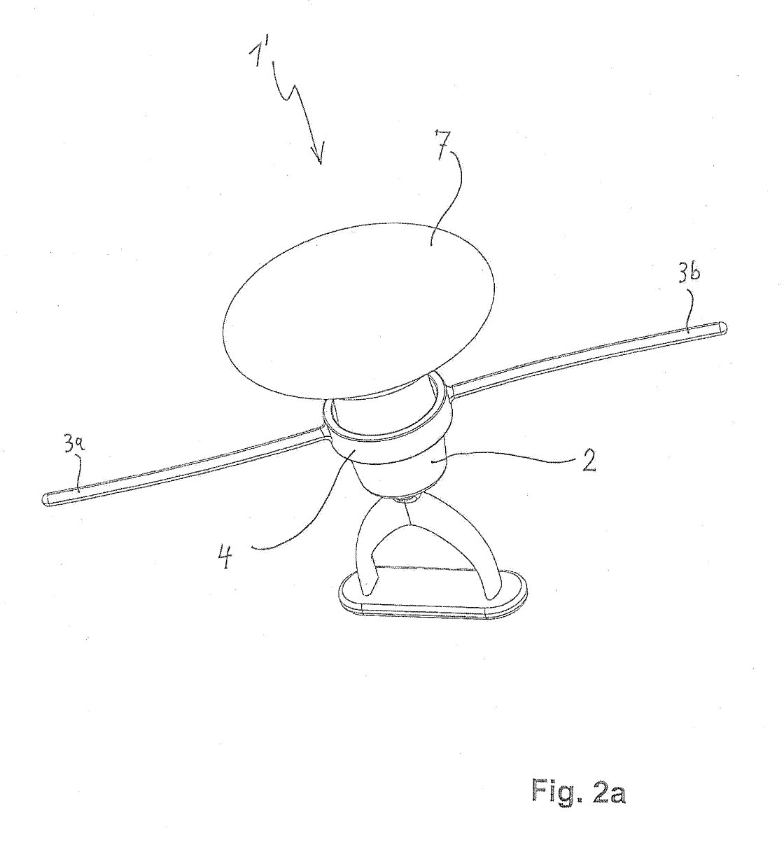

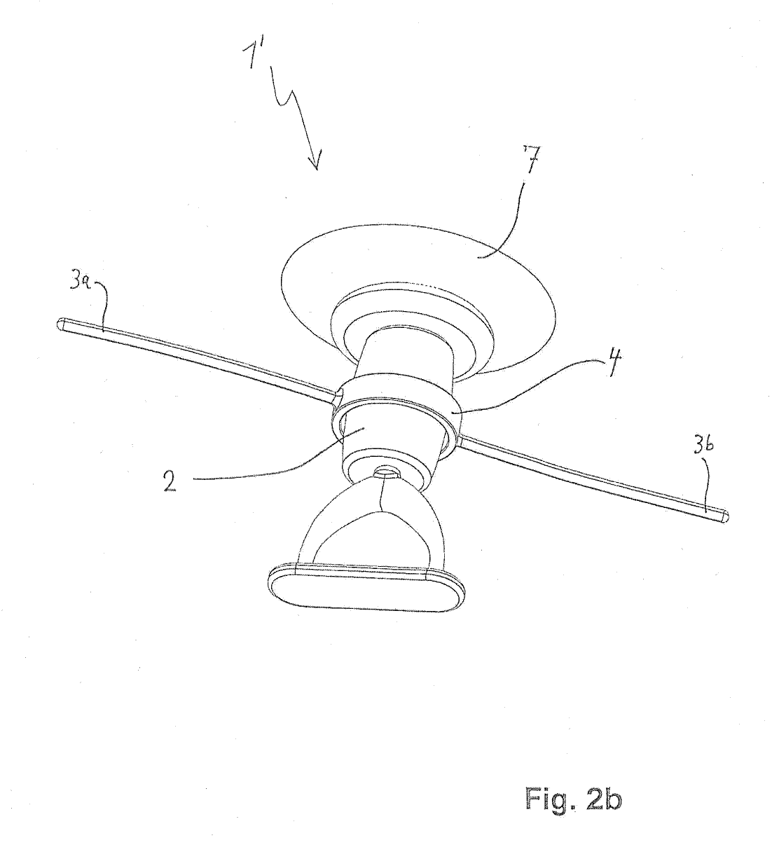

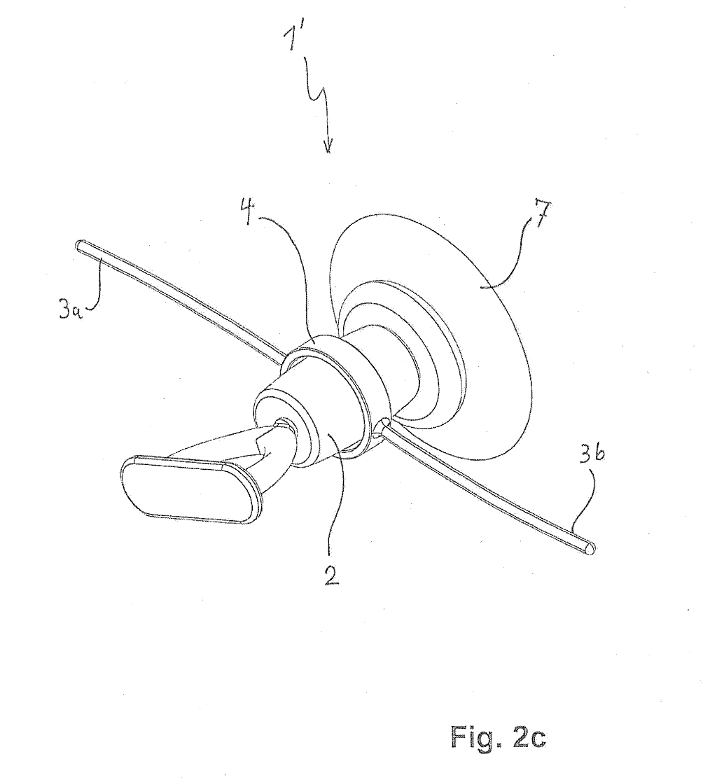

The embodiments of the invention, which are schematically spatially represented in FIGS. 1a, 1b, 1c, 2a, 2b, 2c of the drawings, comprise an arrangement 1; 1′, which is used to adjust and permanently fix the relative position between an actuator end piece 2 of an active hearing aid implant, which is not shown in greater detail in the drawings, and one or multiple surrounding bones in the human middle ear. The actuator end piece 2 has a shape which extends along a cylindrical axis and, in the embodiments shown, is elongate.

The actuator end piece 2, as depicted in the drawings, is slightly curved in a barrel shape, includes different cross-sections along the cylindrical axis thereof, and has a slight bulge in the radial direction in the middle region thereof. In other, non-illustrated embodiments, the actuator end piece is cylindrical and has identical cross-sections along the cylindrical axis thereof.

The actuator end piece 2 is typically designed as an inductor coil or as a piezoelectric coupling rod or as a magnet of an FMT (=“floating mass transducer”).

The arrangement 1; 1′ comprises two (or multiple, in the case of embodiments not represented in the drawings) coupling elements 3a, 3b, by which the actuator end piece 2, after having been surgically inserted into a human middle ear, is anchored on one or multiple surrounding bones. The embodiments shown comprise the radially protruding coupling elements 3a, 3b, each of which is bar-shaped or rod-shaped. Simple coupling elements made from wire are also possible.

The active hearing aid implant according to the invention is characterized in that the arrangement 1; 1′ has a sliding ring 4, which is geometrically designed in such a way that the ring 4 slides over the cylindrical actuator end piece 2 and then holds the actuator end piece in the radial direction, while the sliding ring 4 remains linearly displaceable in the axial direction of the actuator end piece 2, against a frictional resistance, if necessary, and two or multiple radially protruding coupling elements 3a, 3b are fastened radially outwardly on the sliding ring 4 for anchoring the sliding ring 4 on one or multiple surrounding bones after the arrangement 1; 1′ has been surgically inserted into a human middle ear.

The drawing figures also show two coupling elements 3a, 3b, which are disposed opposite one another on the sliding ring 4 and protrude radially from the sliding ring 4. Embodiments in which at least three coupling elements are provided, which are arranged so as to be symmetrically distributed around the periphery of the sliding ring 4 and which protrude radially from the sliding ring 4, are also possible, but are not shown in the drawing figures.

FIGS. 1a, 1b and 1c show a first embodiment of the active hearing aid implant according to the invention, comprising a coupler crown 5 on the lower free end of the actuator end piece 2 and a slotted bell 6 as the receiving part for the natural stapes or an Ω-shaped, artificial base of stapes as the connection element to the inner ear. Instead of the bell 6, a clip can be provided as the fastening element in embodiments not represented in the drawing.

A tympanic membrane plate 7 is mounted at the upper end of the actuator end piece 2 and, in the implanted state, rests against the tympanic membrane or a flat piece of cartilage inserted between the tympanic membrane and the actuator end piece 2.

FIGS. 2a, 2b and 2c show an alternative embodiment of the active hearing aid implant according to the invention, characterized by a direct coupling of the lower free end of the actuator end piece 2 to the natural stapes or to an Ω-shaped, artificial base of stapes as the connection element to the inner ear. A fastening device included in the embodiments of FIGS. 1a, 1b and 1c, comprising a coupler crown 5 and a bell 6, is unnecessary in the embodiments in FIGS. 2a to 2c.

The remote ends of the coupling elements 3a, 3b protruding from the sliding ring 4 are designed to be inserted into natural, anatomically present openings in the surrounding mastoid bone, in particular. in a tendon channel of the stapedius muscle and/or the tensor tympani muscle, in order to insert and anchor the active hearing aid implant in a human middle ear.

The figures in the drawings show embodiments of the invention in which the sliding ring 4 is designed as a closed ring. While not shown, however, the sliding ring 4 can be designed as a half-open ring having a slot in order to achieve greater radial flexibility. For that matter, the inventive arrangement 1; 1′ also may include a biologically active coating, in particular, a growth-inhibiting and/or growth-promoting and/or antibacterial coating, provided on the surface of the implant, at least in sections.

A material having a memory effect, in particular a nickel-titanium alloy, preferably Nitinol, is used as the material for the arrangement 1; 1′ or parts thereof. The sliding ring 4 is preferably made from metal and/or ceramic and/or plastic.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An active hearing aid implant comprising an arrangement for the adjustment and permanent fixation of a relative position between an actuator end piece of the active hearing aid implant and one or multiple surrounding bones in the human middle ear;
wherein the actuator end piece has an elongate, cylindrical shape that extends along a cylindrical axis;
wherein two or multiple coupling elements anchor the actuator end piece to the one or multiple surrounding bones of the middle ear after being surgically inserted into the human middle ear;
wherein a sliding ring is geometrically designed to slide over the cylindrical actuator end piece and then hold the actuator end piece in radial direction while remainING linearly displaceable in the axial direction of the actuator end piece, against a frictional resistance, if necessary; and
wherein two or multiple radially protruding coupling elements are fastened radially outwardly on the sliding ring for anchoring the sliding ring on the one or multiple surrounding bones after the arrangement has been surgically inserted into the human middle ear.

2. The hearing aid implant according to claim 1, wherein the sliding ring is made from one or more of metal, ceramic and plastic.

3. The hearing aid implant according to claim 1, wherein the sliding ring is a closed ring or a half-open ring having a slot.

4. The hearing aid implant according to claim 1, wherein the cylindrical actuator end piece is an identical cross-section along the cylindrical axis thereof.

5. The hearing aid implant according to claim 1, wherein the cylindrical actuator end piece is barrel-shaped, having different cross-sections along the cylindrical axis thereof including a radial bulge in a middle region thereof.

6. The hearing aid implant according to claim 1, wherein the actuator end piece comprises an inductor coil, a piezoelectric coupling rod or a magnet of a floating mass transducer (FMT).

7. The hearing aid implant according to claim 1, wherein the radially protruding coupling elements for anchoring the sliding ring are bar-shaped or rod-shaped.

8. The hearing aid implant according to claim 1, wherein the radially protruding coupling elements for anchoring the sliding ring are made from wire.

9. The hearing aid implant according to claim 1, wherein exactly two coupling elements are provided that are disposed opposite one another on the sliding ring and protrude radially from the sliding ring.

10. The hearing aid implant according to claim 1, characterized in that at least three coupling elements are provided that are arranged to be symmetrically distributed around a periphery of the sliding ring and to protrude radially from the sliding ring.

11. The hearing aid implant according to claim 1, wherein remote ends of the coupling elements protruding from the sliding ring are configured to be inserted into natural, anatomically present openings in a surrounding mastoid bone of the human middle ear after the hearing aid implant is surgically inserted, to anchor the implant.

12. The hearing aid implant according to claim 11, wherein the natural, anatomically present openings are one or more of a tendon channel of the stapedius muscle and a tensor tympani muscle.

13. The hearing aid implant according to claim 1, wherein a fastening device is mounted on a free lower end of the actuator end piece directed toward an inner-ear region in the implanted state that is configured to be be fastened on the free lower end of the actuator end piece by a coupler crown and to be fastened on a stapes or a portion of the stapes by a clip or a bell that is slotted.

14. The hearing aid implant according to claim 1, wherein a tympanic membrane plate is mounted on a free upper end of the actuator end piece which, in the implanted state, is directed toward a tympanic membrane region and rests against a tympanic membrane or a flat piece of cartilage inserted between the tympanic membrane and the actuator end piece.

15. The hearing aid implant according to claim 1, wherein the arrangement is made from material having a memory effect, entirely or in part, at least in the region of the sliding ring, the coupling elements or both.

16. The hearing aid implant according to claim 15, wherein the material is a nickel-titanium alloy, preferably from Nitinol.

17. The hearing aid implant according to claim 16, wherein the material is, preferably from Nitinol.

18. The hearing aid implant according to claim 1, wherein a biologically active coating is provided on the arrangement, at least in sections.

19. The hearing aid implant according to claim 18, wherein the biologically active coating is one or more of a growth-inhibiting coating, a growth-promoting coating and an antibacterial coating.

20. An active hearing aid implant, comprising:
an actuator end piece formed formed as an elongate cylinder with a cylindrical axis;
a sliding ring with two or multiple rod-shaped coupling elements that extend radially outward from the sliding ring;
wherein the sliding ring is configured to slide over the actuator end piece and hold the actuator end piece in a radial direction while remaining linearly displaceable along the cylindrical axis of the actuator end piece, against a frictional resistance, if necessary; and
wherein the two or multiple coupling elements are configured to anchor the actuator end piece to one or multiple surrounding bones in a human middle ear after the active hearing aid implant is surgically inserted.
